(19) United States
(12) Patent Application Publication
(10) Pub. No.: US 2018/0015699 A1
(43) Pub. Date: Jan. 18, 2018

(54) METAL-BONDED SUBSTRATE

(71) Applicant: Corning Precision Materials Co., Ltd., Chungcheongnam-do (KR)

(72) Inventors: Bo Gyeong Kim, Chungcheongnam-do (KR); Hyun Bin Kim, Chungcheongnam-do (KR); Sung Hoon Lee, Chungcheongnam-do (KR)

(73) Assignee: Corning Precision Materials Co., Ltd., Chungcheongnam-do (KR)

(21) Appl. No.: 15/545,793

(22) PCT Filed: Jan. 6, 2016
(86) PCT No.: PCT/KR2016/000085

§ 371 Date: Jul. 24, 2017

(30) Foreign Application Priority Data
Jan. 23, 2015 (KR) 10-2015-0011025

(51) Int. Cl. B32B 17/06; B32B 15/20

(52) U.S. Cl. CPC B32B 17/061; B32B 15/20

(57) ABSTRACT

The present invention relates to a metal-bonded substrate and, more specifically, to a metal-bonded substrate in which the bonding force between a nonconductive substrate and a metal layer bonded to each other is remarkably improved. To this end, the present invention provides a metal-bonded substrate comprising: a substrate; a metal layer formed on the substrate; and a self-assembled monomolecular layer formed between the substrate and the metal layer, and composed of a silane chemically linking the substrate and the metal layer, wherein the end group of the silane is composed of an aminosilane containing a saturated or unsaturated hetero atom of a six-membered ring.

### BACKGROUND

### Field

The present disclosure generally relates to a metal-bonded substrate. More particularly, the present disclosure relates to a metal-bonded substrate in which bonding force between a nonconductive base substrate and a metal layer bonded thereto is significantly improved.

### Description of Related Art

Glass is used in a variety of applications, such as in a range of functional containers, vehicles, and constructional materials, and is used in various electronic devices, such as smartphones and display devices, due to possessing high levels of light transmittance, superior thermal stability, and superior mechanical properties. In modern industry, technology-intensive fields have greater demand for materials suitable for specific applications. Thus, industrial fields in which glass having the above-mentioned properties is required are increasing. In particular, electrical connections among devices that form fine electrical circuit patterns are essential in electronic/electrical devices, such as touchscreens, display devices, and semiconductor substrate materials. When a glass material is used in the manufacturing of such electronic/electrical devices, it is essential to deposit a metal, such as copper (Cu), on the glass material to form an electrical circuit.

In general, when glass is applied to a display manufacturing process, a seed layer for increasing adhesive strength is formed on a glass plate using a sputtering apparatus, and subsequently, Cu is deposited on the seed layer. However, when a vacuum deposition apparatus, such as the sputtering apparatus, is used, many problems may occur, since such an apparatus may be relatively expensive, the operational costs of the apparatus may be high, the apparatus may have a large volume, and the entire process may consume a relatively large amount of time. In particular, an apparatus in the related art is designed to deposit Cu mainly in a two-dimensional (2D) manner, i.e. in a single direction. Thus, an apparatus must be structurally modified in order to uniformly deposit Cu in all directions in a three-dimensional (3D) manner. However, this may undesirably result in additional costs and increase the volume of the apparatus.

Electroless Cu plating is a process of plating a medium with Cu by precipitating Cu through the chemical reduction of Cu²⁺ ions. Electroless Cu plating is used in a variety of industrial fields, since the entire process thereof is performed on a solution basis, all samples can be plated, and mass production is possible. However, since glass-based materials have poor adhesion with Cu, methods or technologies able to increase the adhesive strength therebetween are required.

### RELATED ART DOCUMENT

Patent Document 1: Korean Patent No. 10-0846318 (Jul. 9, 2008)

### BRIEF SUMMARY

Various aspects of the present disclosure provide a metal-bonded substrate in which the bonding force between a nonconductive base substrate and a metal layer bonded thereto is significantly improved.

According to an aspect, a metal-bonded substrate includes: a base substrate; a metal layer disposed on the base substrate; and a self-assembled monolayer (SAM) disposed between the base substrate and the metal layer, the SAM being formed from a silane chemically connecting the metal layer to the base substrate. The terminal group of silane contains aminosilane including a saturated or unsaturated 6-membered ring with at least one heteroatom.

The silane may be one or a combination of two or more selected from a candidate group consisting of: 3-aminopropyl-trimethoxy silane (APTMS), 3-mercaptopropyl-trimethoxy silane (MPTMS), triazinethiol silane (TESPA), trimethoxysilylpropyl diethylenetriamine (AEAPTMS), and diphenylphosphino-ethyltriethoxy silane (DPPETES).

The aminosilane may be one or a combination of two or more selected from a candidate group consisting of triazinethiol (NH(CH₂)₃Si(OMe)₃), triazinethiol ((CH2)₂Si(OMe)₃), trioxanethiol (NH(CH₂)2Si(OMe)₃), pyranthiol (NH(CH₂)2Si(OMe)₃), thiopyranthiol (NH(CH₂)2Si(OMe)₃), triphosphorthiol (NH(CH₂)3Si(OMe)₃), stanabenzene (NH(CH₂)2Si(OMe)₃), hexazine (NH(CH₂)3Si(OMe)₃), pyridine (NH(CH₂)2Si(OMe)₃), tetrazine (NH(CH₂)3Si(OMe)₃), and 2triazinethiol-vertical (NH(CH₂)3Si(OMe)₃).

The base substrate may be implemented as a glass substrate.

The metal layer may be formed from copper.

According to the present disclosure as set forth above, the metal-bonded substrate includes the SAM between the non-conductive base substrate and the metal layer, the SAM being formed from silane the terminal group of which contains aminosilane including a saturated or unsaturated 6-membered ring with at least one heteroatom. The base substrate and the metal layer of the metal-bonded substrate can be chemically connected via the SAM, thereby obtaining superior bonding force between the base substrate and the metal layer. It is therefore possible to overcome the problem of lack of bonding force that would otherwise occur in the electroless plating process of the related art.

According to the present disclosure, it is possible to dispense with the electroless plating process of the related art, thereby reducing processing costs.

### BRIEF DESCRIPTION OF THE DRAWINGS

FIG. 1 is a cross-sectional view schematically illustrating a metal-bonded substrate according to an exemplary embodiment;

FIG. 2 to FIG. 6 are molecular structure diagrams representing the structures of several types of silane of an SAM, in which:

FIG. 2 is a molecular structure diagram representing the structure of APTMS;

FIG. 3 is a molecular structure diagram representing the structure of MPTMS;

FIG. 4 is a molecular structure diagram representing the structure of TESPA;

FIG. 5 is a molecular structure diagram representing the structure of AEAPTMS; and

FIG. 6 is a molecular structure diagram representing the structure of DPPETES;

FIG. 7 to FIG. 16 are molecular structure diagrams representing the structures of terminal groups of silane, in which:

FIG. 7 is a molecular structure diagram representing the structure of thiazine;

FIG. 8 is a molecular structure diagram representing the structure of trioxane;

FIG. 9 is a molecular structure diagram representing the structure of pyran;

FIG. 10 is a molecular structure diagram representing the structure of thiopyran;

FIG. 11 is a molecular structure diagram representing the structure of triphosphor;

FIG. 12 is a molecular structure diagram representing the structure of stanabenzene;

FIG. 13 is a molecular structure diagram representing the structure of hexazine;

FIG. 14 is a molecular structure diagram representing the structure of pyridine;

FIG. 15 is a molecular structure diagram representing the structure of 2triazinethiol-vertical; and

FIG. 16 is a molecular structure diagram representing the structure of tetrazine; and

FIG. 17 is a molecular structure diagram comparatively representing a difference in binding energy depending on whether or not an SAM is formed between a base substrate and a metal layer.

### DETAILED DESCRIPTION

Reference will now be made in detail to a metal-bonded substrate according to the present disclosure, embodiments of which are illustrated in the accompanying drawings and described below, so that a person skilled in the art to which the present disclosure relates could easily put the present disclosure into practice.

Throughout this document, reference should be made to the drawings, in which the same reference numerals and symbols will be used throughout the different drawings to designate the same or like components. In the following description, detailed descriptions of known functions and components incorporated herein will be omitted in the case that the subject matter of the present disclosure is rendered unclear by the inclusion thereof.

As illustrated in FIG. 1, a metal-bonded substrate 100 according to an exemplary embodiment may be applied to an electronic device such as a touchscreen and a display, a semiconductor substrate, or the like. The metal-bonded substrate 100 is patterned to provide an electrical circuit to internal components while protecting the internal components from the external environment. The metal-bonded substrate 100 includes a base substrate 110, a metal layer 120, and a self-assembled monolayer (SAM) 130.

The metal layer 120 is bonded to the base substrate 110 via the SAM 130. That is, the base substrate 110 and the metal layer 120 are chemically connected to the bottom portion and the top portion of the SAM 130 (referring to FIG. 1), thereby forming a bonded structure.

According to the present embodiment, the base substrate 110 may be formed from a non-conductive material. For example, the base substrate 110 may be formed from a glass material, such as soda-lime glass or non-alkali glass. However, this is merely for illustrative purposes, the base substrate 110 may be formed from a variety of materials, the characteristics of which are similar or equal to those of the glass material.

The metal layer 120 is disposed on top of the base substrate 110. According to the present embodiment, the metal layer 120 may be formed from copper (Cu). In general, a Cu layer is formed on the surface of glass by performing electroless Cu plating on glass. The reaction of Cu plating on glass is expressed as Cu²⁺+2e⁻→Cu⁰. This indicates that plated Cu is simply deposited on the glass surface and does not have any chemical bonds. Thus, Cu and glass have a low level of bonding force. According to the present embodiment, the base substrate 110 and the metal layer 120 are bonded to each other via the SAM 130, thereby significantly improving the bonding force therebetween. This will be described in greater detail hereinafter.

The SAM 130 is disposed between the base substrate 110 and the metal layer 120. The SAM 130 according to the present embodiment is formed from silane. Silane allows molecules thereof to be regularly arranged on the base substrate 110 formed from glass, thereby facilitating the formation of a monolayer.

When the SAM 130 is formed from silane in this manner, the silanol group of silane forms a covalent bonds with the surface of the base substrate 110 formed from glass. In a high- or low-pH solution, the terminal group of silane is dehydrogenated, thereby functioning as a nucleophile. Consequently, the terminal group of silane forms a covalent bonds with the metal layer 120 formed from Cu.

When a variety of heterocyclic compound terminal groups containing nitrogen, sulfur, oxygen, or the like, able to increase chemical affinity to Cu, is used, it becomes possible to increase the bonding force between the SAM 130 formed from silane and the metal layer 120. In addition, it is possible to increase the bonding force between the SAM 130 and the metal layer 120 using the characteristics of n-conjugated molecules chemically bonded to the surface of metal.

Thus, the terminal group of silane of the SAM 130 according to the present embodiment may contain aminosilane including a saturated or unsaturated 6-membered ring with at least one heteroatoms, in which the above-described two characteristics are combined.

When the SAM 130 is formed from the terminal group of silane forming which contains aminosilane including a saturated or unsaturated 6-membered ring with at least one heteroatom, as described above, both sides of the SAM 130 can be chemically bonded to the base substrate 110 and the metal layer 120, whereby the bonding force between the base substrate 110 and the metal layer 120 connected via the SAM 130 can be significantly improved.

Silane forming the SAM 130 according to the present embodiment may be one or a combination of two or more selected from the candidate group consisting of: 3-aminopropyl-trimethoxy silane (APTMS), 3-mercaptopropyl-trimethoxy silane (MPTMS), triazinethiol silane (TESPA), trimethoxysilylpropyl diethylenetriamine (AEAPTMS), and diphenylphosphino-ethyltriethoxy silane (DPPETES).

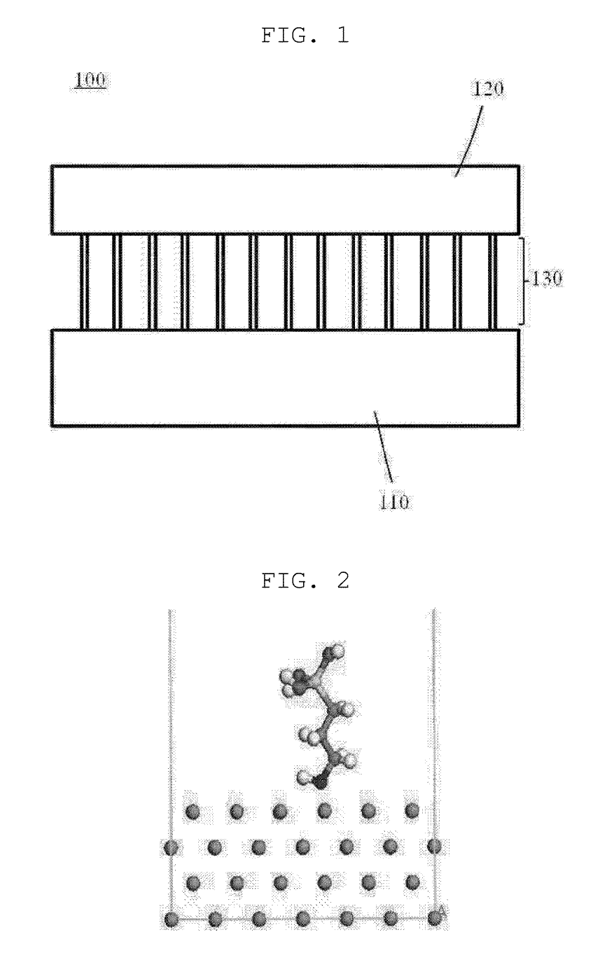

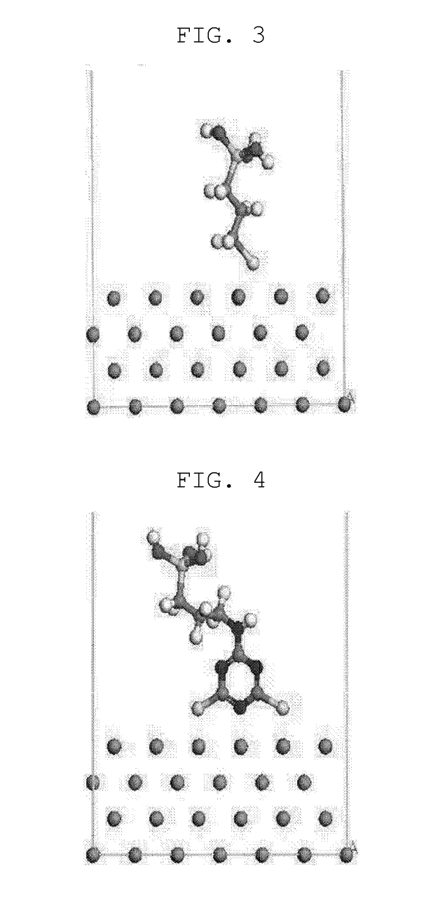

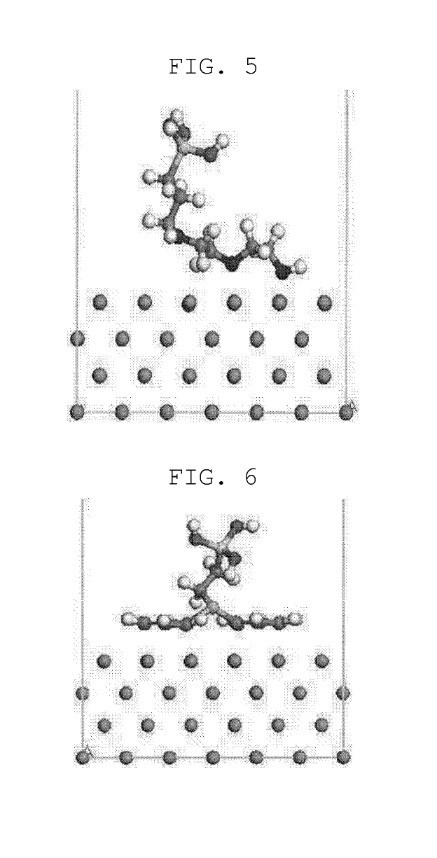

As illustrated in FIG. 2 to FIG. 6, when APTMS is used as the silane, the binding energy E_{binding} of silane to the metal layer formed from Cu (particles arrayed on a grid on the drawings) is measured as −2.85 eV. When MPTMS is used as the silane, the binding energy E_{binding} of silane to the metal layer is measured as −3.31 eV. When TESPA is used as the silane, the binding energy E_{binding} of silane to the metal layer is measured as −4.78 eV. When AEAPTMS is used as the silane, the binding energy E_{binding} of silane to the metal layer is measured as −4.89 eV. When DPPETES is used as the silane, the binding energy E_{binding} of silane to the metal layer is measured as 4.50 eV. A lower level of binding energy indicates a greater degree of bonding force between silane and the metal layer. In addition, the binding energy does not indicate binding energy between silane and Cu in case silane is formed between a glass substrate and Cu, but binding energy between silane itself and Cu in case the glass substrate is excluded.

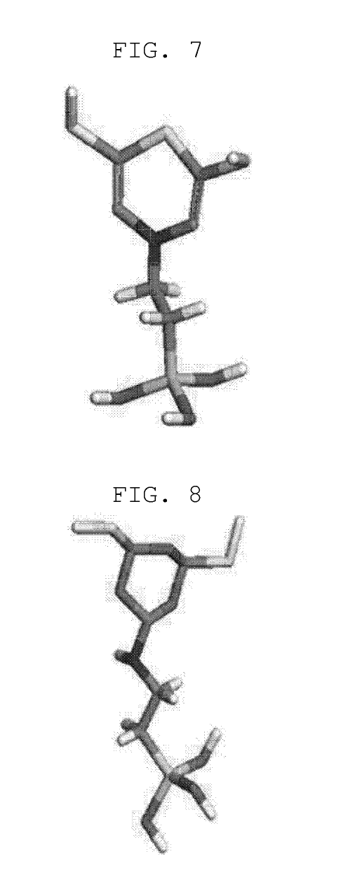

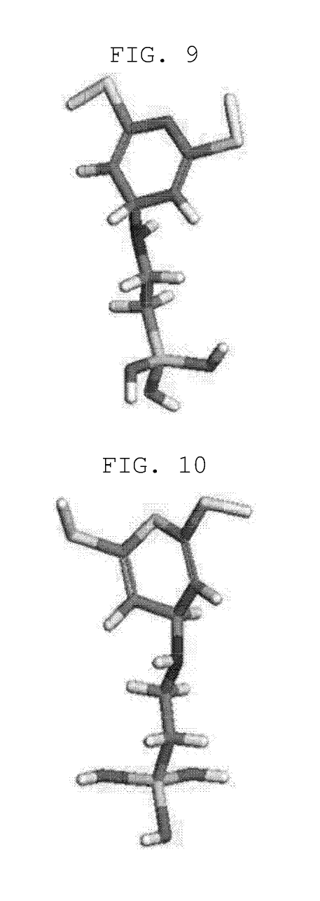

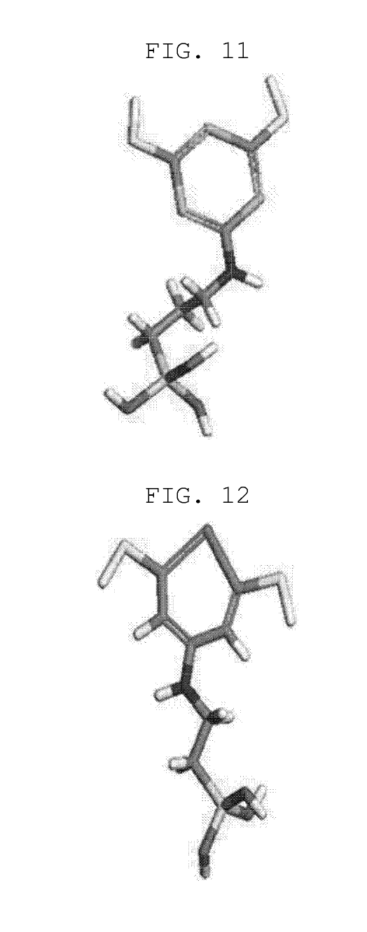

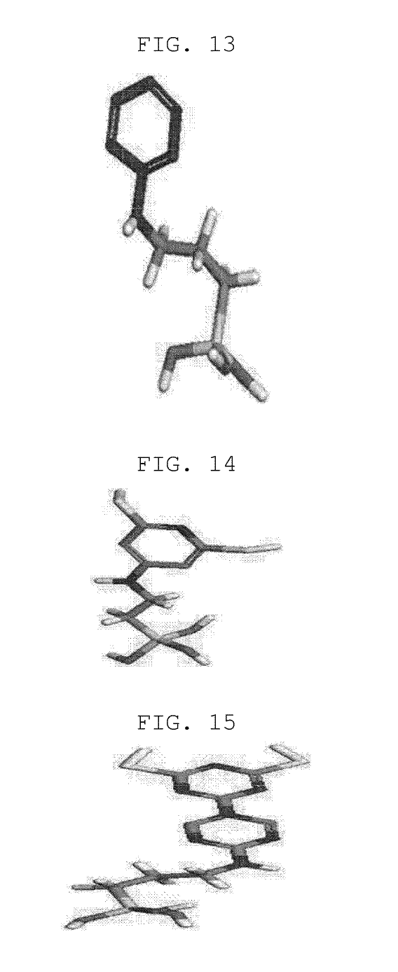

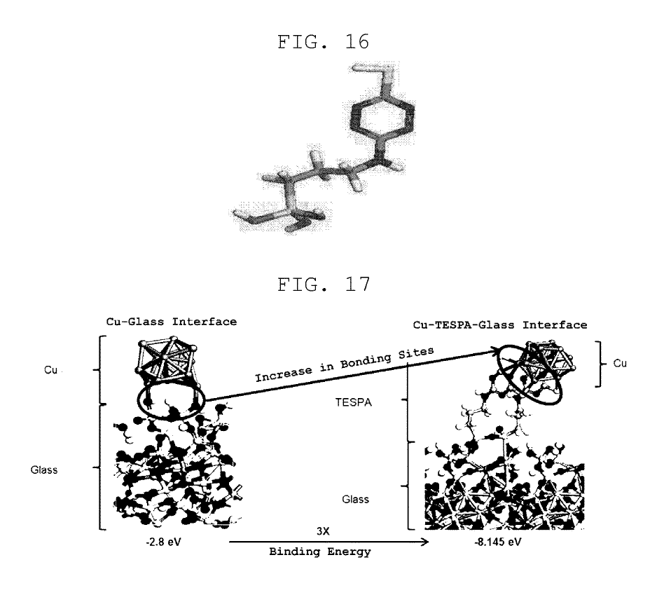

In addition, as illustrated in FIG. 7 to FIG. 16, the terminal group of silane may be one or a combination of two or more selected from the candidate group consisting of triazinethiol (NH(CH₂)₃Si(OMe)₃), triazinethiol ((CH2)₂Si(OMe)₃), trioxanethiol (NH(CH₂)2Si(OMe)₃), pyranthiol (NH(CH₂)2Si(OMe)₃), thiopyranthiol (NH(CH₂)2Si(OMe)₃), triphosphorthiol (NH(CH₂)3Si(OMe)₃), stanabenzene (NH(CH₂)2Si(OMe)₃), hexazine (NH(CH₂)3Si(OMe)₃), pyridine (NH(CH₂)2Si(OMe)₃), tetrazine (NH(CH₂)3Si(OMe)₃), and 2triazinethiol-vertical (NH(CH₂)3Si(OMe)₃).

FIG. 17 is a molecular structure diagram comparatively representing a difference in binding energy depending on whether or not a self-assembled monolayer is formed between a base substrate and a metal layer. The left part of the molecular structure diagram represents a structure in which Cu is directly formed on a glass substrate. In this case, the binding energy E_{binding} between the glass substrate and Cu is −2.8 eV. In contrast, the right part of the molecular structure diagram represents a structure in which silane, i.e. TESPA having one of the terminal groups illustrated in FIG. 7 to FIG. 16, is formed between a glass substrate and Cu according to an embodiment of the present invention. In this case, the binding energy E_{binding} between the TESPA and Cu is 8.145 eV. In this manner, when the glass substrate and Cu are connected via silane, the binding energy E_{binding} is increased, and more particularly, is approximately tripled. This indicates that the bonding force between the glass substrate and Cu is significantly increased by silane.

The binding energy when the glass substrate and Cu are connected via silane is increased to be greater than when Cu is directly formed on the glass substrate because the terminal group of silane which contains aminosilane including a saturated or unsaturated 6-membered ring with at least one heteroatom increases bonding sites in which Cu is bonded with silane compared to the case Cu is directly connected to the glass substrate.

When the binding energy E_{binding} between silane and Cu in case silane is formed between the glass substrate and Cu is compared to the binding energy E_{binding} between silane itself and Cu as illustrated in FIG. 2 to FIG. 6, it is appreciated that the binding energy E_{binding} between silane and Cu in the glass-silane-Cu structure is increased to be significantly greater than the binding energy E_{binding} between silane and Cu in the silane-Cu structure.

As described above, the metal-bonded substrate 100 includes the SAM 130 between the non-conductive base substrate 110 and the metal layer 120, the SAM 130 being formed from silane the terminal group of which contains aminosilane including a saturated or unsaturated 6-membered ring with at least one heteroatom. Due to this structure, the base substrate 110 and the metal layer 120 of the metal-bonded substrate 100 can be chemically connected, thereby obtaining superior bonding force between the base substrate 110 and the metal layer 120.

The foregoing descriptions of specific exemplary embodiments of the present disclosure have been presented with respect to the drawings. They are not intended to be exhaustive or to limit the present disclosure to the precise forms disclosed, and obviously many modifications and variations are possible for a person having ordinary skill in the art in light of the above teachings.

It is intended therefore that the scope of the present disclosure not be limited to the foregoing embodiments, but be defined by the Claims appended hereto and their equivalents.

### EXPLANATION OF REFERENCE NUMERALS

100: metal-bonded substrate, 110: base substrate

120: metal layer, 130: self-assembled monolayer

What is claimed is:

1. A metal-bonded substrate comprising:
a base substrate;
a metal layer disposed on the base substrate; and
a self-assembled monolayer disposed between the base substrate and the metal layer, the self-assembled monolayer being formed from a silane chemically connecting the metal layer to the base substrate,
wherein a terminal group of the silane contains aminosilane including a saturated or unsaturated 6-membered ring with at least one heteroatom.

2. The metal-bonded substrate of claim 1, wherein the silane comprises one or a combination of two or more selected from a candidate group consisting of: 3-aminopropyl-trimethoxy silane (APTMS), 3-mercaptopropyl-trimethoxy silane (MPTMS), triazinethiol silane (TESPA), trimethoxysilylpropyl diethylenetriamine (AEAPTMS), and diphenylphosphino-ethyltriethoxy silane (DPPETES).

3. The metal-bonded substrate of claim 1, wherein the aminosilane comprises one or a combination of two or more selected from a candidate group consisting of triazinethiol (NH(CH₂)₃Si(OMe)₃), triazinethiol ((CH2)₂Si(OMe)₃), trioxanethiol (NH(CH₂)2Si(OMe)₃), pyranthiol (NH(CH₂)2Si(OMe)₃), thiopyranthiol (NH(CH₂)2Si(OMe)₃), triphosphorthiol (NH(CH₂)3Si(OMe)₃), stanabenzene (NH(CH₂)2Si(OMe)₃), hexazine (NH(CH₂)3Si(OMe)₃), pyridine (NH(CH₂)2Si(OMe)₃), tetrazine (NH(CH₂)3Si(OMe)₃), and 2triazinethiol-vertical (NH(CH₂)3Si(OMe)₃).

4. The metal-bonded substrate of claim 1, wherein the base substrate comprises a glass substrate.

5. The metal-bonded substrate of claim 1, wherein the metal layer is formed from copper.
